(19) United States
(12) Patent Application Publication
(10) Pub. No.: US 2026/0340655 A1
(43) Pub. Date: Oct. 29, 2026

(54) METHOD AND SYSTEM FOR CAREER MANAGEMENT BASED ON PARTICIPATION VERIFICATION

(71) Applicant: team91 Co.,Ltd., Seoul (KR)

(72) Inventor: Jae Woong HWANG, Seoul (KR)

(21) Appl. No.: 19/460,241

(22) Filed: Jan. 26, 2026

(30) Foreign Application Priority Data
Apr. 27, 2025 (KR) 10-2025-0055039

(51) Int. Cl. G06Q 30/018; H04L 9/40

(52) U.S. Cl. CPC G06Q 30/018; H04L 63/0838

(57) ABSTRACT

The present disclosure provides a career management method performed by a career management apparatus, the method comprising: (a) determining a project for participation verification; (b) registering information of a user or another person who participated in the project and verifying participation information using contact information; and (c) managing career information based on the verified participation information.

### CROSS-REFERENCE TO RELATED APPLICATION

This application claims priority to and the benefit of Korean Patent Application No. 10-2025-0055039, filed on Apr. 27, 2025, the disclosure of which is incorporated herein by reference in its entirety.

### BACKGROUND

### Technical Field

The present invention relates to career management technology, and more particularly, to a career management method and system based on participation verification for proving and managing an individual's career based on verification that the individual has participated in a specific project in a content field or an art field, and for providing support for networking and collaboration among workers in the content field or the art field.

### Background Art

In the content field or the art field, there are many workers who work as freelancers, and, in a case in which such workers work while being affiliated with a specific project, the workers have difficulty in career certification because the workers do not enter into an employment contract or are not enrolled in four major social insurances such as employment insurance. Accordingly, a freelancer's career management method relies on an unofficial method based on a resume, and thus has a problem in that reliability is low and a verification process is insufficient. In addition, in the existing freelancer market, there are difficulties in efficient workforce matching and in data-based contracts that are reliable due to problems such as absence of a career certification system, employment instability, and lack of a network, and there is a problem in that employment instability and a platform-based networking and matching system are insufficient.

### SUMMARY

### Technical Problem

An object of the present invention is to provide a career management method and apparatus for proving participation of a user in a project through identity verification and mutual verification among participants, and providing career certification based on verified participation information.

Another object of the present invention is to provide a career management method and apparatus for registering and verifying participation information indicating that a user participated in a specific project, using a user name and contact information.

Another object of the present invention is to provide a career management method and apparatus for facilitating networking among users, such as collaboration matching, by constructing a database of projects and project-specific participation information.

The technical problems of the present invention are not limited to the foregoing, and other technical problems not mentioned herein will become apparent to a person having ordinary skill in the art from the following description.

### Technical Solution

In a first aspect, the present invention provides a career management method comprising: (a) determining a project for participation verification; (b) registering information of a user or another person who participated in the project and verifying participation information using contact information; and (c) managing career information based on verified participation information.

In some embodiments, step (a) may include identifying whether a project corresponding to project information is stored in the database; when the project is not stored in the database, generating a new project based on the project information; when participation information for the new project is verified for at least a threshold number of users, verifying the new project; and when verification of the new project is completed, storing the new project in the database.

In some embodiments, step (b) may include receiving, for the project, a selection of specific participation information already registered in the project information or new participation information; and, when the participation information corresponds to the user using the user terminal, performing participation verification for the project based on a phone number and a unique identifier of the user.

In some embodiments, step (b) may further include receiving, from a user who has completed participation verification, participation information of another person for the project; registering the participation information of the other person as participation information for the project; and, when the other person is not a registered member, generating an individual verification link and transmitting the individual verification link to a user terminal of the other person.

In some embodiments, when the participation information verification module 122 generates an individual verification link and/or a project verification link, the link is provided to one or more users through the user terminal 110 so that the users can access a participation information registration screen for a corresponding project and complete participation verification using a phone number. For example, the project verification link may be generated as a project invitation link and shared with colleagues who worked together on a specific project, and the colleagues may select or add participation information through the link and perform participation verification using a phone number.

In some embodiments, step (c) may include, when participation information of another person is registered and verified as participation information for a project through user verification of the other person, adding, to career information of the other person, information on completion of colleague verification with a user who input the participation information of the other person, and adding, to career information of the user who input the participation information of the other person, information on completion of colleague verification with the other person.

In some embodiments, step (b) may further include generating a project verification link in response to a request from a user who has completed user verification; and receiving, through the project verification link, registration of participation information from a plurality of other participants with the project.

In some embodiments, step (b) may further include, when registration and verification of participation information associated with a specific user who participated in the project are completed, providing, to a user who has already registered and verified participation information for the project, a notification indicating that registration and verification of the participation information of the specific user have been completed.

In some embodiments, step (c) may include generating career information of a user based on information associated with a project for which the participation information has been registered and verified; and generating a resume based on project information, participation information, and personal information registered in the career information.

In some embodiments, step (a) may further include, based on contact information stored in the user terminal, providing, to a user, a project in which participation information of another person whose contact information matches the contact information stored in the user terminal is registered.

In some embodiments, the method may further include: receiving a data search request based on information on a project, a user, or a job category (also referred to as a department); When the data search request is received based on information on a project, searching for and providing, from the database, a project title, detailed information on the project, or participation information of the project; when the data search request is received based on information on a user, searching for and providing, from the database, user information, participation information verified by the user, or career information of the user; and when the data search request is received based on information on a job category, searching for and providing, from the database, information on a user who has verified participation information in the job category.

In a second aspect, the present invention may provide a career management apparatus comprising: a project management module configured to determine a project for participation verification; a participation information verification module configured to register information of a user or another person who participated in the project and to verify participation information using contact information; and a career information management module configured to manage career information based on verified participation information.

In some embodiments, the career management apparatus may further comprise a database configured to store and manage project information, project-specific participation information, and user-specific participation information and career information.

In a third aspect, the present invention provides a non-transitory computer-readable medium storing instructions that, when executed by one or more processors, cause the one or more processors to perform the career management method.

### Advantageous Effects

According to the present invention, a talent pool in a content field and/or an art field may be databased, and strong networking capable of connecting media professionals and production companies worldwide may be provided.

Further, according to the present invention, participation information may be secured through verification among participants of a project, reliability of a career may be improved based on the participation information, and efficient project production may be supported through AI-based, cross-border matching of project professionals and linkage with local production resources.

### BRIEF DESCRIPTION OF THE DRAWINGS

FIG. 1 is a configuration diagram illustrating a career management system according to a preferred embodiment of the present invention.

FIG. 2 is a block diagram illustrating a career management apparatus according to an embodiment.

FIG. 3 is a flowchart illustrating a career management method according to an embodiment.

FIGS. 4A to 9C are exemplary diagrams for explaining a career management method according to an embodiment.

### DETAILED DESCRIPTION

Hereinafter, advantages and features of the present invention, and methods for achieving the advantages and features will become apparent with reference to the embodiments described in detail below in conjunction with the accompanying drawings. However, the present invention is not limited to the embodiments disclosed below, and may be implemented in various different forms, and the embodiments are provided only to make the disclosure of the present invention complete and to fully inform a person having ordinary skill in the art to which the present invention pertains of the scope of the invention, and the present invention is defined only by the scope of the claims. Like reference numerals refer to like elements throughout the specification. The term “and/or” includes each of the recited items and one or more of all combinations thereof. Although terms such as “first” and “second” are used to describe various elements, components, and/or sections, the elements, components, and/or sections are not limited by the terms. The terms are used only for the purpose of distinguishing one element, component, or section from another element, component, or section. Accordingly, a first element, a first component, or a first section mentioned below may also be a second element, a second component, or a second section within the technical spirit of the present invention.

In addition, identification symbols (e.g., a, b, c, etc.) in respective steps are used for convenience of description, and the identification symbols do not indicate an order of the respective steps. Unless a specific order is clearly described in context, the respective steps may occur differently from the stated order. That is, the respective steps may occur in the same order as stated, may be performed substantially simultaneously, or may be performed in a reverse order.

Terms used herein are for describing embodiments and are not intended to limit the present invention. As used herein, the singular forms include the plural forms as well, unless the context clearly indicates otherwise. As used herein, “comprises” and/or “comprising” specify the presence of stated components, steps, operations, and/or elements, but do not preclude the presence or addition of one or more other components, steps, operations, and/or elements.

Unless otherwise defined, all terms (including technical and scientific terms) used herein may be used in meanings commonly understood by a person having ordinary skill in the art to which the present invention pertains. Further, terms defined in generally used dictionaries are not interpreted ideally or excessively unless clearly and specifically defined otherwise.

In describing embodiments of the present invention, if it is determined that detailed descriptions of known functions or configurations may unnecessarily obscure the subject matter of the present invention, the detailed descriptions will be omitted. Further, terms described below are terms defined in consideration of functions in the embodiments of the present invention, and may vary according to the intention or custom of a user or an operator. Therefore, the definitions should be made based on the content throughout the specification.

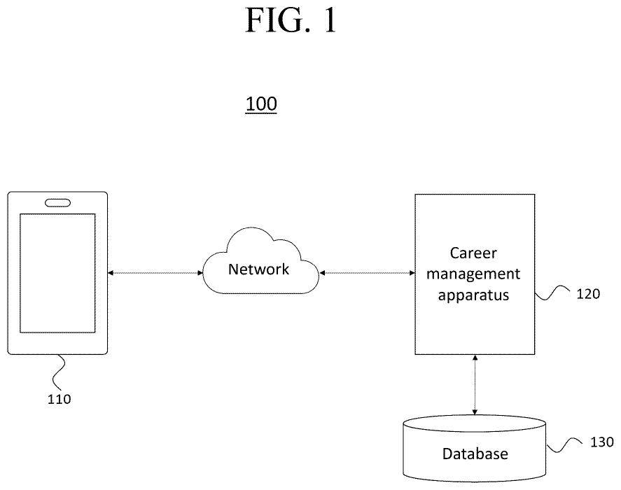

FIG. 1 is a configuration diagram illustrating a career management system according to a preferred embodiment of the present invention.

Referring to FIG. 1, the career management system 100 includes a user terminal 110, a career management apparatus 120, and a database 130. The user terminal 110 and the career management apparatus 120 may be connected via a network.

The user terminal 110 is used by a user who needs participation verification and/or career certification for a specific project, and may receive user inputs and may transmit and receive data for performing the career management method. In some embodiments, the user terminal 110 refers to any type of hardware device including at least one processor, and, depending on embodiments, may be understood as encompassing a software configuration operating on the hardware device. For example, the user terminal 110 may correspond to a smartphone or a tablet PC, and may be understood as including both a user client and an application executed on each device, but is not limited thereto.

The career management apparatus 120 provides a career management service based on project information and/or user participation information transmitted from the user terminal 110, and may be implemented as one or more servers connected to a plurality of user terminals 110 and providing participation verification for users who have participated in a specific project based on information input among the plurality of user terminals 110, and also provide career certification according to the participation verification. As used herein, a project includes all content (media) production work such as a film, a drama, a music video, or short-form content, and “participation” in a project refers to involvement of staff and/or cast in producing project.

The database 130 is connected to the career management apparatus 120, and stores and manages data input from the user terminal 110 and/or data received from one or more external devices or systems. In some embodiments, the database 130 may store and manage project information, project-specific participation information, user-specific participation information, and/or user-specific history information generated based on the participation information. For example, the database 130 may store and manage open data from The Movie Database (TMDB) managed in a manner contributed by users and/or from Korean Movie Database (KMDB) managed by the Korean Film Archive. Such data may be processed to represent projects for which verification has been completed.

In some embodiments, the database 130 maintains one or more indices for improving performance and consistency of the career management service. For example, the database 130 may maintain (i) a project fingerprint index for duplicate project detection, (ii) a participation credential index keyed by a pair of a project identifier and a user identifier for idempotent verification processing, and (iii) a job-category index keyed by a job category for servicing a search request based on job category information. By maintaining the indices, the career management apparatus 120 may service search requests with reduced query latency and with reduced risk of inconsistent query results when multiple users register or verify participation information concurrently.

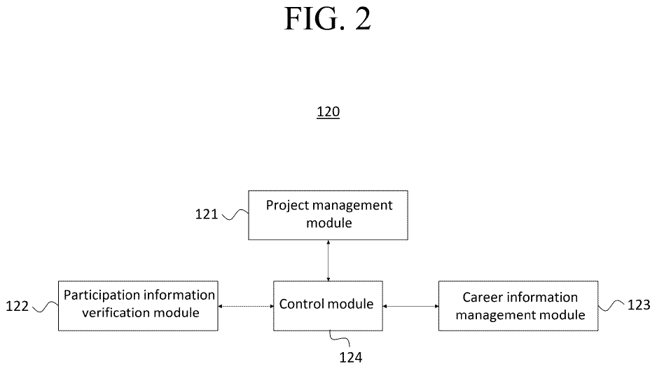

FIG. 2 is a block diagram illustrating a career management apparatus according to an embodiment.

The career management apparatus 120 is configured to perform the career management method of the present disclosure. Referring to FIG. 2, the career management apparatus 120 includes a project management module 121, a participation information verification module 122, a career information management module 123, and a control module 124. The control module 124 is configured to control operations of the project management module 121, the participation information verification module 122, and the career information management module 123, and to control data flow among the modules.

In some embodiments, the career management apparatus 120 may be implemented as one or more computing devices that install and execute application of program instructions for performing the career management method of the present disclosure, and may include a user interface to control input and output of data. As used herein, the computing device refers to any type of hardware device including at least one processor, and, depending on embodiments, may be understood as encompassing a software configuration operating on the hardware device. For example, the computing device may be understood as including a smartphone, a tablet PC, a desktop, a laptop, and both a user client and an application executed on each device, but is not limited thereto. The project management module 121 is configured to manage project information. In some embodiments, the project management module 121 may store and manage, in the database 130, project information input from the user terminal 110, or may determine and provide, among projects stored and managed in the database 130, a project for which registration of participation information is required in response to a request from the user terminal 110.

The participation information verification module 122 is configured to receive user information associated with a specific user from the user terminal 110, register the user information as participation information for a specific project, and verify the participation information using unique identifier of the user including, for example, a user name, a stage name, a phone number, or an email address.

In some embodiments, when participation verification for participation information is completed, the participation information verification module 122 stores verification completion information in association with the participation information and displays verification-related tags on a user interface. For example, when a user registers participation information, a “self registration” tag may be displayed, and, when identity verification for the participation information is completed, an “identity verification” tag may be displayed. In addition, for each participation information, whether identity verification has been performed, a date on which identity verification was performed, and whether colleague verification has been performed may be displayed. The career information management module 123 is configured to generate career information corresponding to a user-specific filmography using verified participation information, and may generate a resume in a document format based on the career information. For example, upon verification of participation information, the participation information may be linked to the user's career information or a resume, etc.

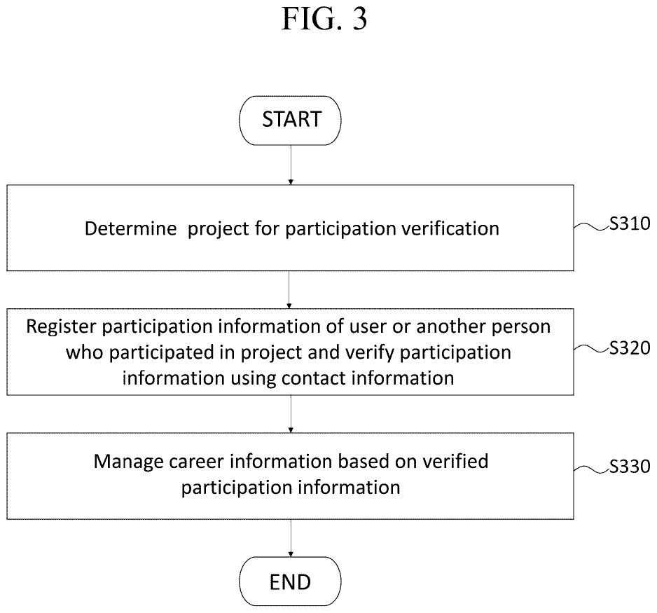

Operations performed by the modules of the career management apparatus 120 illustrated in FIG. 2 will be described below in detail with reference to FIG. 3. Although respective steps to be described with reference to FIG. 3 are described as being performed by different modules, the present disclosure is not limited thereto. In some embodiments, at least some of the respective steps may be performed by a same component and/or by one or more other modules.

FIG. 3 is a flowchart illustrating a career management method according to an embodiment.

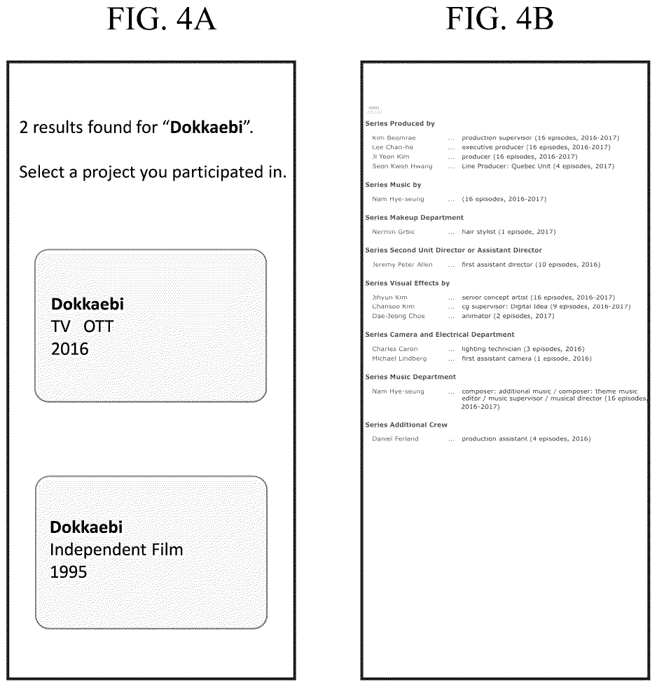

Referring to FIG. 3, the project management module 121 determines a project for participation verification (step S310). In some embodiments, the project management module 121 may identify whether a project corresponding to project information input from the user terminal 110 is stored in the database 130. The project information may include, for example, a title, a type, and/or a director name. The database 130 may store and manage open data, and, when the project information input from the user terminal 110 is included in the open data, the project management module 121 may determine the corresponding project as the project for participation verification. For example, as illustrated in FIG. 4A, when the project is stored in the database 130, the project management module 121 may provide information retrieved from the database 130 to the user terminal 110 and may receive, from the user terminal 110, a selection or confirmation.

In some embodiments, when the project management module 121 receives project information (e.g., a title, a type, and/or a director name), the project management module 121 generates a normalized project fingerprint used for duplicate detection. The normalized project fingerprint may be generated by normalizing a project title string, removing noise characters, and combining the normalized title with at least one additional attribute such as a project type or a director name. The project management module 121 may query the database 130 using the normalized project fingerprint to reduce generation of duplicate projects caused by inconsistent user inputs, thereby improving database consistency and reducing downstream verification conflicts.

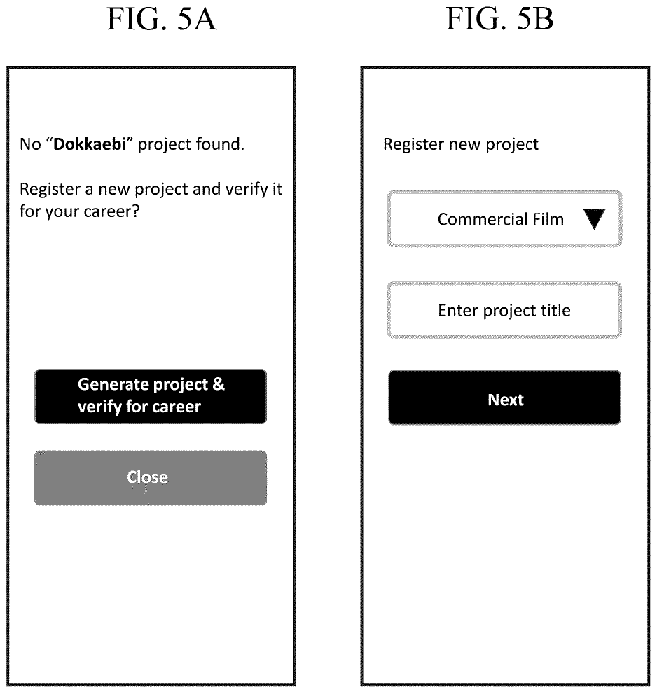

In an embodiment, when the project is not stored in the database 130, the project management module 121 may generate a new project based on project information. For example, when the project is not stored in the database 130, as illustrated in FIGS. 5A and 5B, the project management module 121 may provide, to the user terminal 110, a message indicating that the project is not stored in the database 130. When the project management module 121 receives, from the user terminal 110, a selection to generate a new project, the project management module 121 may receive a project type and a project title and may generate the new project. In addition, the project management module 121 may provide, to the user terminal 110, a project information page as illustrated in FIG. 4B, may receive project information from the user terminal 110, and may generate the new project.

In some embodiments, when participation information for the new project is verified for at least a threshold number of users, the project management module 121 may verify the new project. Upon completion of the verification, the project may be stored in the database 130. Project verification refers to verification to impart reliability to the project information, and may include review by an administrator of the career management apparatus 120. Based on a review result, the new project may be approved or rejected. Specifically, with respect to project verification, a project may be classified as an unverified project, an under-review project, or a verified project. The unverified project may correspond to a case in which the review is rejected or a case in which the number of users who have verified participation information is less than three. The under-review project may correspond to a case of a one-person project for which registration is completed or a case in which three or more users have verified participation information for a general project. The verified project may correspond to a case in which the administrator has completed the review, or a case in which the project is included in open data and is already stored and managed in the database 130. As used herein, a “one-person project” refers to a project carried out by a single person, such as content for a YouTube video or channel in which the person performs directing, scriptwriting, filming, acting, or similar tasks. A “general project” refers to a project other than a one-person project.

In some embodiments, the project verification status described herein (e.g., unverified, under-review, verified) is maintained as a state machine in the database 130. The project management module 121 may transition a project status from unverified to under-review when a count of distinct participation verification credentials associated with the project satisfies a threshold, and may transition the project status to verified upon administrator approval. In this embodiment, the transition is performed only when the participation verification credentials satisfy uniqueness constraints (e.g., distinct user identifiers) to prevent artificial inflation of the threshold count, and the transition is committed atomically with a corresponding update of a project record in the database 130, thereby preventing a mismatch between a displayed project verification status and an actual stored status.

In an embodiment, the project management module 121 may provide, to a user, a project in which participation information of another person whose contact information matches contact information stored in the user terminal 110 is registered. In this embodiment, when the user terminal 110 performs membership registration or login, the project management module 121 may obtain the contact information stored in the user terminal 110 and may recommend, to the user, a project associated with the contact information. For example, the recommended project may include a project for which a user having a contact detail identical to a contact detail included in the contact information stored in the user terminal 110 has performed participation verification, or a project in which the user having the contact detail identical to the contact detail included in the contact information is registered as a director or a producer.

In some embodiments, when providing a recommended project based on contact information stored in the user terminal 110, the career management apparatus 120 processes contact information in a privacy-preserving manner. For example, instead of storing raw contact information, the career management apparatus 120 may store a hashed representation of contact information in the database 130 and perform matching using hashed values.

In this embodiment, the project management module 121 may compare hashed contact information obtained from the user terminal 110 with hashed contact information stored in the database 130 to identify a matching user and to recommend a project associated with the matching user, thereby reducing exposure of personally identifiable information while maintaining matching functionality. In some embodiments, when contact information stored in the user terminal 110 is updated, the career management apparatus 120 updates a corresponding hashed contact information entry in the database 130 and invalidates outdated matching indices. For example, the project management module 121 may maintain a contact-hash index that maps hashed contact values to user identifiers, and may update the contact-hash index as part of a transactional update with user profile data to prevent stale recommendations or incorrect matches. In some embodiments, the hashed representation of contact information is a salted hash. For example, the career management apparatus 120 may generate the salted hash by applying a hash function to (i) contact information and (ii) a salt value, and may store the salted hash in the database 130. In this embodiment, the project management module 121 performs contact matching by generating a salted hash for contact information obtained from the user terminal 110 using the same salt value and comparing the generated salted hash with the salted hash stored in the database 130, thereby reducing exposure of raw contact information while maintaining accurate contact matching.

The participation information verification module 122 is configured to register participation information of a user or another person who participated in a project and verify participation information using contact information (step S320). In some embodiments, for the project, the participation information verification module 122 may receive, from the user terminal 110, a selection of specific participation information already registered in the project information or new participation information. For example, as illustrated in FIG. 4B, when project information is provided to the user terminal 110, based on the names and job categories listed in the project information, the participation information verification module 122 may receive, from the user terminal 110, a selection of participation information to be registered when participation information to be registered by the user is present in the project information; otherwise, the participation information verification module 122 may receive new participation information. The new participation information may include, for example, a name, a nickname, a stage name, a phone number, a job category, a job, or episode information.

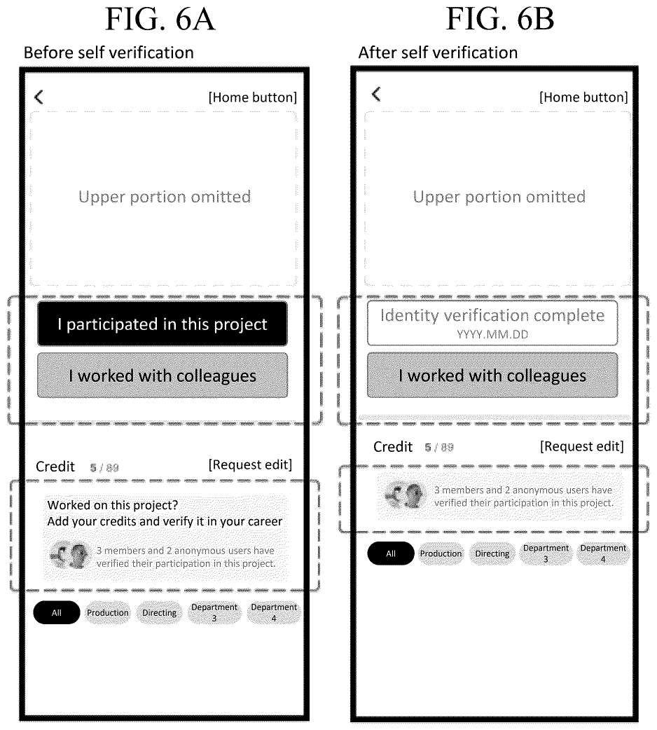

In an embodiment, when the selected specific participation information or the new participation information corresponds to the user using the user terminal 110, the participation information verification module 122 may perform participation verification for the project based on a phone number and unique identifier of the user. For example, after validating the user's phone number, the participation information verification module 122 may complete verification of participation information based on a match of one or more of a name, an email address, a member key, or an activity name (stage name) associated with unique member identifier of the user information. Participation verification operations described below are performed in the same manner. When the user registers participation information, a “self registration” tag may be displayed for the participation information, and, when upon completion of verification for participation information of the user, as illustrated in FIGS. 6A and 6B, a “identity verification” tag may be displayed for the participation information.

In some embodiments, the participation information verification module 122 performs idempotent processing for repeated verification requests. For example, when a verification request is retransmitted due to network delay or client retry, the participation information verification module 122 may determine whether a participation verification credential having an identical project identifier and user identifier is already stored in the database 130, and, when the credential is already stored, the module 122 may return an existing verification result without duplicating a credential record. In some embodiments, storing the credential record and updating an associated verification tag displayed in a user interface are performed in a single transactional operation to prevent partial updates that may otherwise lead to inconsistent verification status display.

In some embodiments, the participation verification credential described herein may be implemented as a signed token generated by the participation information verification module 122 using a server-side signing key. For example, the signed token may include a payload including at least a project identifier, a user identifier, a role category, and a verification timestamp, and may further include a verification type indicating identity verification and/or colleague verification. Prior to storing the participation verification credential in the database 130, the participation information verification module 122 may validate the signed token by verifying a signature of the signed token using the server-side signing key, thereby preventing acceptance of a forged or modified credential.

In some embodiments, the participation verification credential has an expiration time and is rejected when the expiration time has elapsed. For example, the expiration time may be included in the payload of the signed token, and the participation information verification module 122 may determine whether a current time exceeds the expiration time prior to storing the participation verification credential or prior to using the participation verification credential for generating career information or a resume. When the expiration time has elapsed, the participation information verification module 122 may reject the participation verification credential and may request re-verification of participation information, thereby reducing reuse of stale credentials and improving integrity of verified participation information.

In another embodiment, when the participation information verification module 122 receives, from a user who has completed participation verification, participation information of another person for the project, the participation information verification module 122 may register the received participation information as participation information for the project. When the other person is not a registered member based on the received participation information, the participation information verification module 122 may generate an individual verification link and transmit the individual verification link to a user terminal of the other person. For example, as illustrated in FIGS. 6A and 6B, the user who has completed participation verification may select an option indicating “I worked with a colleague”, and may search for a specific other person among registered members or input participation information such as a name, contact information, and a job category. The participation information verification module 122 may determine whether member information includes a phone number matching the input contact information. When the other person corresponding to the participation information input by the user is a registered member, the participation information verification module 122 may register the participation information as participation information for the project, and, when the other person is not a registered member, the participation information verification module 122 may transmit an invitation link to a user terminal of the other person, for example, via an individual verification link. Through the individual verification link, the other person may perform identity verification to complete participation verification even when the other person is not a registered member of the career management service provided by the career management apparatus 120. When the other person does not complete membership registration, the other person may be verified as participation information for the project, however, the verification is not linked to career information.

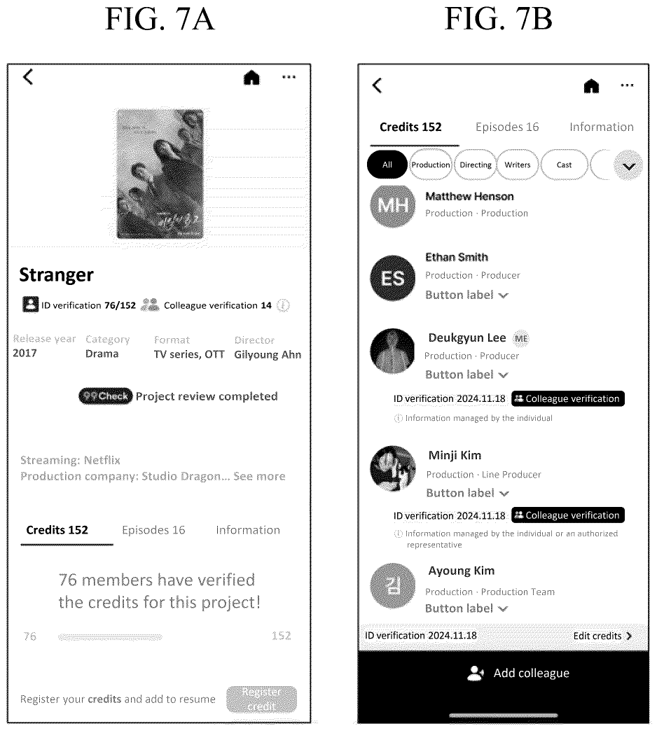

In some embodiments, when participation information of a user is registered by another person, an “another person registration” tag may be displayed in association with the registered participation information. When the other person completes verification for the participation information, that is, when verification of the participation information is completed by a person different from the person who registered the participation information, a “colleague verification” tag may be displayed in association with the registered participation information for both the user who registered the participation information and the user who completed the verification. For example, referring to FIGS. 7A and 7B, for a specific project, the number of users who have performed identity verification and colleague verification may be displayed. Further, for each participation information, whether identity verification has been performed, a date on which identity verification was performed, and whether colleague verification has been performed may be displayed.

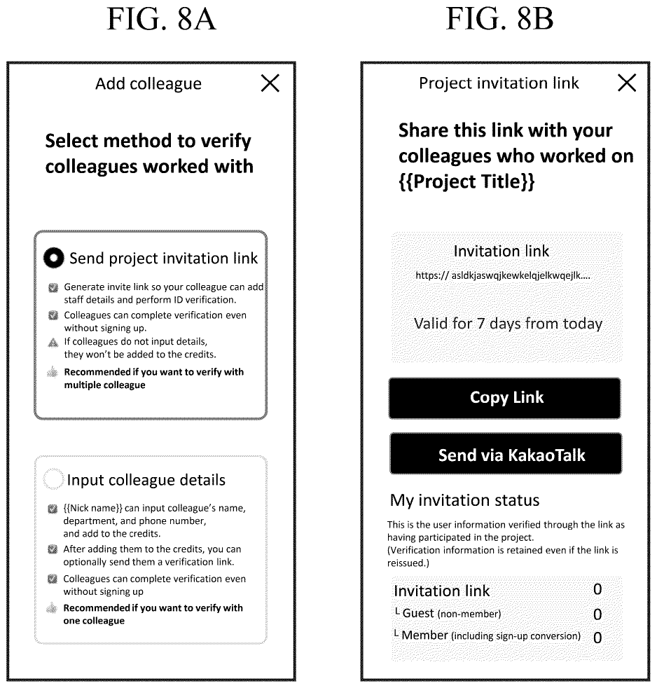

In another embodiment, the participation information verification module 122 may generate a project verification link in response to a request from a user who has completed user verification, and may receive, through the project verification link, registration of participation information from a plurality of other participants with the project. For example, referring to FIGS. 8A and 8B, the participation information verification module 122 may generate the project verification link as a project invitation link, and the project verification link may be transmitted to a plurality of users via the user terminal 110. The project verification link may be shared with colleagues who worked together on a specific project, and, via the project verification link, the colleagues may select participation information or directly add participation information, and may perform verification using a phone number. In an embodiment, a pop-up message may be provided to prompt membership registration. In an embodiment, for a colleague who does not complete membership registration, only registration of the participation information as a non-member may be completed.

Via the project verification link, another person may perform identity verification even when the other person has not completed membership registration with the career management service provided by the career management apparatus 120. When the other person does not complete membership registration, the other person may be registered as participation information for the project upon completion of identity verification, however, the registration is not linked to career information. When the other person is a registered member and performs verification for participation information for the project, the participation information for the project may be certified as career information of the other person.

In some embodiments, when participation information of a user for a project is registered by another person, the user may review the participation information. When the participation information is correct, the user may input additional detailed information of the participation information (e.g., episode participation information) and may complete participation verification. When the participation information is incorrect, the user may delete the participation information of the user registered by the other person and may register new participation information and complete participation verification. In this case, when the participation information is deleted, the participation information verification module 122 may provide a notification to a user who registered the participation information.

In some embodiments, when registration and verification of participation information associated with a specific user who participated in the project are completed, the participation information verification module 122 may provide, to a user who has already registered and verified participation information for the project, a notification indicating that the registration and verification of the participation information of the specific user have been completed.

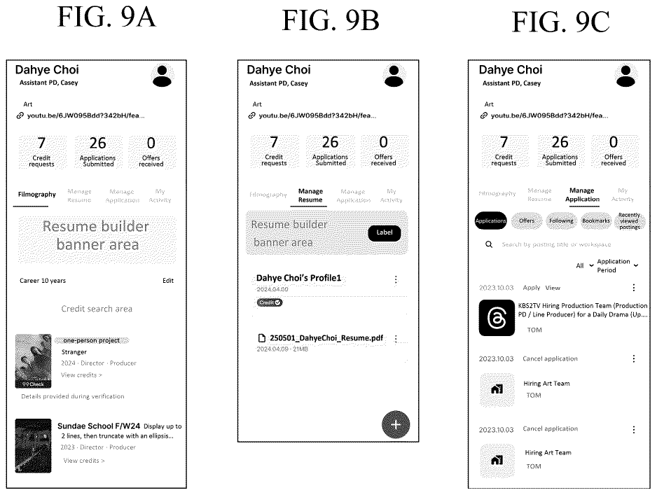

The career information management module 123 is configured to manage career information based on verified participation information (step S330). In some embodiments, the career information management module 123 may generate career information of a user based on information associated with one or more projects for which participation information has been registered and verified, and may generate a resume based on project information, participation information, and personal information registered in the career information. The career information may correspond to a filmography. When one or more projects for which participation verification has been completed exist, the career information management module 123 may provide the projects as a filmography list, and the list may include, for example, a project title, a project participation verification status, a job category or detailed job category information, a project image, project release information, episode participation information, or character detail information. For example, referring to FIG. 9A, a filmography may be generated based on a project for which participation verification of a user has been completed, and, referring to FIG. 9B, a resume in a document form may be generated based on the filmography.

In some embodiments, when participation information of another person is registered and verified as participation information for a project through user verification of the other person, the career information management module 123 may add, to career information of the other person, information on completion of colleague verification with a user who input the participation information of the other person, and may add, to career information of the user who input the participation information of the other person, information on completion of colleague verification with the other person.

In an embodiment, the career management apparatus 120 may further include an application management module (not shown). The application management module is configured to manage a posting received from the user terminal 110 or a direct proposal to a specific user, and to manage application history for the posting, for performing project production with a user in a specific occupation. In this embodiment, as illustrated in FIG. 9C, the application management module may manage posting history to which the user has applied, and may manage proposals received by the user, users followed by the user, postings bookmarked by the user, and postings recently viewed by the user.

In an embodiment, the career management apparatus 120 may further include a data search module (not shown). In response to a search request from the user terminal 110, the data search module may provide, using data stored in the database 130, requested data. In this embodiment, the data search module may receive a data search request from the user terminal 110 based on project information, user information, or job category information. When the data search request is based on project information, the data search module may search for and provide, from the database 130, project title, detailed project information, or participation information of the project. When the data search request is based on user information, the data search module may search for and provide, from the database 130, user information, participation information verified by the user, or career information of the user. When the data search request is based on job category information, the data search module may search for and provide, from the database 130, information associated with a user who has verified participation information in the job category.

Meanwhile, steps of a method or an algorithm described in connection with embodiments of the present invention may be implemented directly in hardware, implemented in software dules executed by hardware, or implemented by a combination thereof. A software module may reside in Random Access Memory (RAM), Read Only Memory (ROM), Erasable Programmable ROM (EPROM), Electrically Erasable Programmable ROM (EEPROM), flash memory, a hard disk, a removable disk, a CD-ROM, or any form of computer-readable recording medium well known in the technical field to which the present invention pertains.

Components of the present invention may be implemented as programs (or applications) and stored in a medium to be executed in combination with a hardware computing device. Components of the present invention may be executed by software programming or software elements, and similarly, embodiments may be implemented in a programming or scripting language such as C, C++, Java, assembler, etc., including various algorithms implemented by a combination of data structures, processes, routines, or other programming configurations. Functional aspects may be implemented by algorithms executed on one or more processors.

In some embodiments, the technical features described herein provide technical improvements including prevention of unauthorized participation verification via token validation, reduction of duplicate project records via project fingerprinting, consistent state transitions for project verification status via atomic database updates, and privacy-preserving contact matching via hashed contact values. Accordingly, the career management apparatus 120 improves integrity, consistency, and security of participation verification data processed across a plurality of user terminals 110 connected via a network.

Although preferred embodiments of a career management method and apparatus according to the present invention have been described above, the present invention is not limited thereto, and various modifications and variations may be made within the scope of the claims, the detailed description of the invention, and the accompanying drawings, and such modifications and variations also belong to the present invention.

What is claimed is:

1. A computer-implemented method performed by one or more processors of a career management apparatus, the method comprising:
(a) receiving, from a user terminal, project information including at least a title and a project type;
(b) determining whether a project record corresponding to the project information exists in a database, and when the project record does not exist, generating a new project record having an unverified status;
(c) receiving participation information for the project record, the participation information including at least a role category and contact information;
(d) performing identity verification by transmitting a one-time verification code to the contact information and validating an input code received from the user terminal;
(e) in response to successful validation, generating a participation verification credential that is bound to (i) a project identifier of the project record, (ii) a user identifier, (iii) the role category, and (iv) a timestamp, and storing the participation verification credential in the database;
(f) updating a project verification state of the project record based on a count of distinct participation verification credentials associated with the project record satisfying a threshold; and
(g) generating career information for the user identifier based on participation verification credentials stored in the database and generating a resume document based on the career information.

2. The method of claim 1, wherein step (b) comprises generating a project fingerprint by normalizing the title and the project type and querying the database using the project fingerprint.

3. The method of claim 1, wherein the participation verification credential has an expiration time and is rejected when the expiration time has elapsed.

4. The method of claim 1, wherein step (e) comprises generating the participation verification credential as a signed token using a server-side signing key and validating the signed token prior to storing.

5. The method of claim 1, wherein step (f) comprises transitioning the project verification state from the unverified status to an under-review status when the threshold is satisfied, and to a verified status upon administrator approval.

6. The method of claim 1, further comprising generating a project invitation link including a token identifying the project record and an expiration time, and receiving additional participation information through the project invitation link.

7. The method of claim 1, further comprising storing contact information as a salted hash and performing contact matching using the salted hash.

8. The method of claim 1, further comprising, when participation information of another person is registered, transmitting an individual verification link to a terminal of the another person and associating a colleague-verification relationship with a pair of verified user identifiers upon verification completion.

9. The method of claim 1, further comprising providing a notification to a previously verified participant when participation information of a specific user for the project record becomes verified.

10. The method of claim 1, further comprising ingesting open-data project information from a third-party database and marking the project record as verified when the project fingerprint matches the open-data project information.

11. The method of claim 1, further comprising servicing a search request by querying an index over (i) project identifiers and (ii) role categories and returning search results with associated verification states.

12. The method of claim 1, wherein the resume document includes a project title, verification status, role category, and a verification date derived from the participation verification credential.

13. A non-transitory computer-readable medium storing instructions that, when executed by one or more processors, cause the one or more processors to perform the method of claim 1.
